(19) United States
(12) Patent Application Publication
(10) Pub. No.: US 2014/0044823 A1
(43) Pub. Date: Feb. 13, 2014

(54) HEATER FOR THREE-DIMENSIONAL PRINTING

(71) Applicants: Charles E. Pax, Maplewood, NJ (US); Peter Joseph Schmehl, New York, NY (US)

(72) Inventors: Charles E. Pax, Maplewood, NJ (US); Peter Joseph Schmehl, New York, NY (US)

(21) Appl. No.: 13/571,174

(22) Filed: Aug. 9, 2012

(51) Int. Cl. B29C 47/92; B29C 47/96

(52) U.S. Cl. 425/143; 425/151

(57) ABSTRACT

A three-dimensional printer extruder includes a thermal core, a heating element, an extrusion tip and an integrated safety system. In this configuration, the safety system is integrated into the heating element and regulates the temperature to prevent the heating element from exceeding a safe or otherwise desirable operating temperature.

### BACKGROUND

There remains a need for an improved heating element for three-dimensional fabrication system.

### SUMMARY

A three-dimensional printer extruder includes a thermal core, a heating element, an extrusion tip and an integrated safety system. In this configuration, the safety system is integrated into the heating element and regulates the temperature to prevent the heating element from exceeding a safe or otherwise desirable operating temperature.

### BRIEF DESCRIPTION OF THE FIGURES

The invention and the following detailed description of certain embodiments thereof may be understood by reference to the following figures:

FIG. 1 is a block diagram of a three-dimensional printer.

FIG. 2 is a cross-section of the extruder.

FIG. 3 shows an exploded view of an extruder.

FIG. 4 shows a characteristic resistance temperature relationship for a PTC heating element.

### DETAILED DESCRIPTION

All documents mentioned herein are hereby incorporated in their entirety by reference, References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus the term “or” should generally be understood to mean “and/or” and so forth.

The following description emphasizes three-dimensional printers using fused deposition modeling or similar techniques where a bead of material is extruded in a series of two dimensional paths to form a three-dimensional object from a digital model, it will be understood that numerous additive fabrication techniques are known in the art including without limitation multijet printing, stereolithography, Digital Light Processor (“DLP”) three-dimensional printing, selective laser sintering, and so forth. Any such techniques may benefit from the systems and methods described below, and all such printing technologies are intended to fall within the scope of this disclosure, and within the scope of terms such as “printer”, “three-dimensional printer”, “fabrication system”, and so forth, unless a more specific meaning is explicitly provided or otherwise clear from the context.

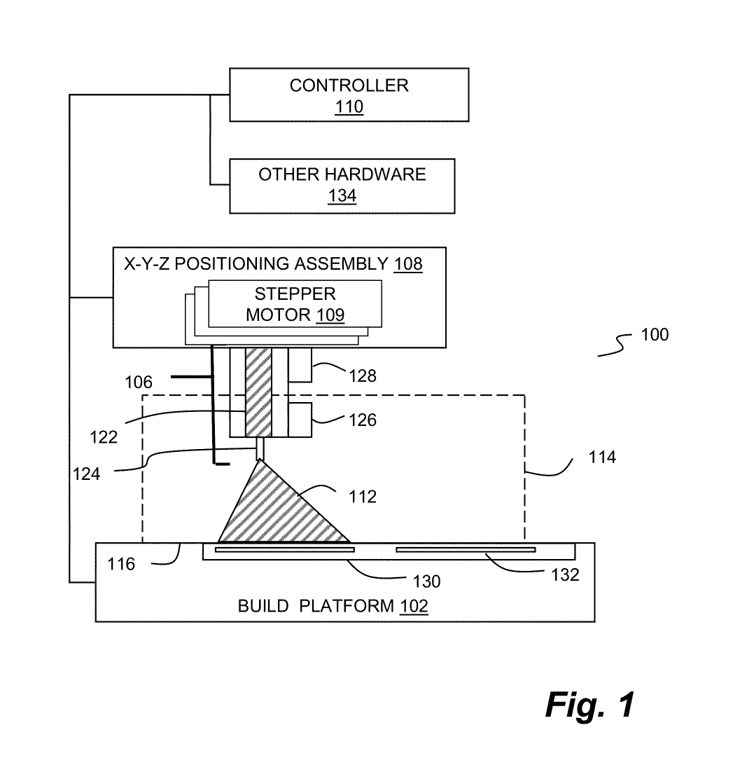

FIG. 1 is a block diagram of a three-dimensional printer. In general, the printer 100 may include a build platform 102, an extruder 106, an x-y-z positioning assembly 108, and a controller 110 that cooperate to fabricate an object 112 within a working volume 114 of the printer 100.

The build platform 102 may include a surface 116 that is rigid and substantially planar. The surface 116 may provide a fixed, dimensionally and positionally stable platform on which to build the object 112. The build platform 102 may include a thermal element 130 that controls the temperature of the build platform 102 through one or more active devices 132, such as resistive elements that convert electrical current into heat, Peltier effect devices that can create a heating or cooling affect, or any other thermoelectric heating and/or cooling devices. The thermal element 130 may be coupled in a communicating relationship with the controller 110 in order for the controller 110 to controllably impart heat to or remove heat from the surface 116 of the build platform 102.

The extruder 106 may include a chamber 122 in an interior thereof to receive a build material. The build material may, for example, include acrylonitrile butadiene styrene (“ABS”), high-density polyethylene (“HDPL”), polylactic acid (“PLA”), or any other suitable plastic, thermoplastic, or other material that can usefully be extruded to form a three-dimensional object. The extruder 106 may include an extrusion tip 124 or other opening that includes an exit port with a circular, oval, slotted or other cross-sectional profile that extrudes build material in a desired cross-sectional shape.

The extruder 106 may include a heater 126 (also referred to as a heating element) to melt thermoplastic or other meltable build materials within the chamber 122 for extrusion through an extrusion tip 124 in liquid form. While illustrated in block form, it will be understood that the heater 126 may include, e.g., coils of resistive wire wrapped about the extruder 106, one or more heating blocks with resistive elements to heat the extruder 106 with applied current, an inductive heater, or any other arrangement of heating elements suitable for creating heat within the chamber 122 sufficient to melt the build material for extrusion. The extruder 106 may also or instead include a motor 128 or the like to push the build material into the chamber 122 and/or through the extrusion tip 124.

In general operation (and by way of example rather than limitation), a build material such as ABS plastic in filament form may be fed into the chamber 122 from a spool or the like by the motor 128, melted by the heater 126, and extruded from the extrusion tip 124. By controlling a rate of the motor 128, the temperature of the heater 126, and/or other process parameters, the build material may be extruded at a controlled volumetric rate. It will be understood that a variety of techniques may also or instead be employed to deliver build material at a controlled volumetric rate, which may depend upon the type of build material, the volumetric rate desired, and any other factors. All such techniques that might be suitably adapted to delivery of build material for fabrication of a three-dimensional object are intended to fall within the scope of this disclosure.

The x-y-z positioning assembly 108 may generally be adapted to three-dimensionally position the extruder 106 and the extrusion tip 124 within the working volume 114. Thus by controlling the volumetric rate of delivery for the build material and the x, y, z position of the extrusion tip 124, the object 112 may be fabricated in three dimensions by depositing successive layers of material in two-dimensional patterns derived, for example, from cross-sections of a computer model or other computerized representation of the object 112. A variety of arrangements and techniques are known in the art to achieve controlled linear movement along one or more axes. The x-y-z positioning assembly 108 may, for example, include a number of stepper motors 109 to independently control a position of the extruder 106 within the working volume along each of an x-axis, a y-axis, and a z-axis. More generally, the x-y-z positioning assembly 108 may include without limitation various combinations of stepper motors, encoded DC motors, gears, belts, pulleys, worm gears, threads, and so forth. For example, in one aspect the build platform 102 may be coupled to one or more threaded rods by worm gears so that the threaded rods can be rotated to provide z-axis positioning of the build platform 102 relative to the extruder 124. This arrangement may advantageously simplify design and improve accuracy by permitting an x-y positioning mechanism for the extruder 124 to be fixed relative to a build volume. Any such arrangement suitable for controllably positioning the extruder 106 within the working volume 114 may be adapted to use with the printer 100 described herein.

In general, this may include moving the extruder 106, or moving the build platform 102, or some combination of these. Thus it will be appreciated that any reference to moving an extruder relative to a build platform, working volume, or object, is intended to include movement of the extruder or movement of the build platform, or both, unless a more specific meaning is explicitly provided or otherwise clear from the context. Still more generally, while an x, y, z coordinate system serves as a convenient basis for positioning within three dimensions, any other coordinate system or combination of coordinate systems may also or instead be employed, such as a positional controller and assembly that operates according to cylindrical or spherical coordinates.

The controller 110 may be electrically or otherwise coupled in a communicating relationship with the build platform 102, the x-y-z positioning assembly 108, and the other various components of the printer 100. In general, the controller 110 is operable to control the components of the printer 100, such as the build platform 102, the x-y-z positioning assembly 108, and any other components of the printer 100 described herein to fabricate the object 112 from the build material. The controller 110 may include any combination of software and/or processing circuitry suitable for controlling the various components of the printer 100 described herein including without limitation microprocessors, microcontrollers, application-specific integrated circuits, programmable gate arrays, and any other digital and/or analog components, as well as combinations of the foregoing, along with inputs and outputs for transceiving control signals, drive signals, power signals, sensor signals, and so forth. In one aspect, this may include circuitry directly and physically associated with the printer 100 such as an on-board processor. In another aspect, this may be a processor associated with a personal computer or other computing device coupled to the printer 100, e.g., through a wired or wireless connection. Similarly, various functions described herein may be allocated between an on-board processor for the printer 100 and a separate computer. All such computing devices and environments are intended to fall within the meaning of the term “controller” or “processor” as used herein, unless a different meaning is explicitly provided or otherwise clear from the context.

A variety of additional sensors and other components may be usefully incorporated into the printer 100 described above. These other components are generically depicted as other hardware 134 in FIG. 1, for which the positioning and mechanical/electrical interconnections with other elements of the printer 100 will be readily understood and appreciated by one of ordinary skill in the art. The other hardware 134 may include a temperature sensor positioned to sense a temperature of the surface of the build platform 102, the extruder 126, or any other system components. This may, for example, include a thermistor or the like embedded within or attached below the surface of the build platform 102. This may also or instead include an infrared detector or the like directed at the surface 116 of the build platform 102.

In another aspect, the other hardware 134 may include a sensor to detect a presence of the object 112 at a predetermined location. This may include an optical detector arranged in a beam-breaking configuration to sense the presence of the object 112 at a predetermined location. This may also or instead include an imaging device and image processing circuitry to capture an image of the working volume and to analyze the image to evaluate a position of the object 112. This sensor may be used for example to ensure that the object 112 is removed from the build platform 102 prior to beginning a new build on the working surface 116. Thus the sensor may be used to determine whether an object is present that should not be, or to detect when an object is absent. The feedback from this sensor may be used by the controller 110 to issue processing interrupts or otherwise control operation of the printer 100.

The other hardware 134 may also or instead include a heating element (instead of or in addition to the thermal element 130) to heat the working volume such as a radiant heater or forced hot air heater to maintain the object 112 at a fixed, elevated temperature throughout a build, or the other hardware 134 may include a cooling element to cool the working volume.

In general, the above system can build a three-dimensional object by depositing lines of build material in successive layers—two-dimensional patterns derived from the cross-sections of the three-dimensional object.

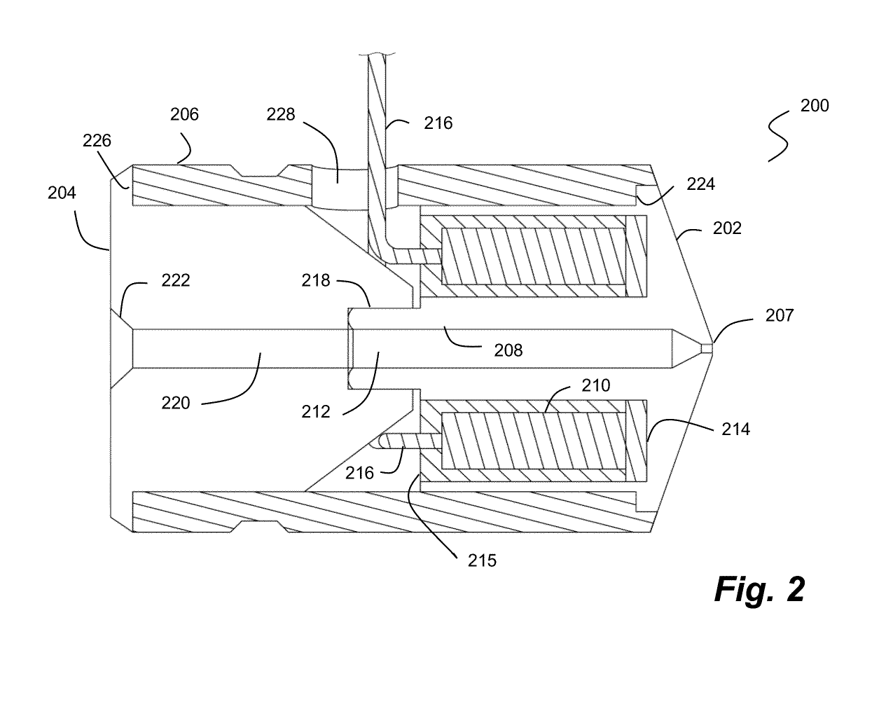

FIG. 2 is a cross section view of the extruder 200 from the three-dimensional printer. In general, the three-dimensional printer may be any fabrication system, such as any of the three-dimensional printers described above or any other fabrication system using fused deposition modeling, stereolithography, Digital Light Processing (“DLP”) three-dimensional printing, selective laser sintering, or any other additive fabrication system/process. For extrusions of thermoplastic or similar build materials, the extruder 200 may include an integrated nozzle 202, a receiver 204, and an insulating sleeve 206.

The integrated nozzle 202 may include an extrusion tip 207, a thermal core 208, and at least one heater 210. The extrusion tip 207 may have any shape necessary to achieve the desired characteristic of the object being manufactured by the three-dimensional printer. The shape of the extrusion tip 207 may be determined by the required flow rate of the build material, the desired shape of the extruded build material and many other variables.

The thermal core 208 may be heated by the heater 210 and contains a chamber 212. The chamber 212 may receive a build material. The build material may, for example, include acrylonitrile butadiene styrene (“ABS”), high-density polyethylene (“HDPL”), polylactic acid (“PLA”), or any other suitable plastic, thermoplastic, or other material that can usefully be extruded to form a three-dimensional object. The build material (not shown) may be received into the chamber 212 of the thermal core 208 and heated by the heater 210 to a sufficient temperature to change the characteristics of the build material for use in the fabrication process, e.g., to liquefy the build material for extrusion through the extrusion tip 207.

While the heater 210 is shown here as two separate elements, it will be understood, as discussed above, that the heater 210 may include, e.g., coils of resistive wire wrapped about the thermal core 208, one or more heating blocks with resistive elements to heat the thermal core 208 with applied current, an inductive heater, or any other arrangement of heating elements suitable for creating heat within the chamber 212 sufficient to melt the build material for extrusion.

The heater 210 may also include an integrated safety system 214. While the safety system 214 is shown here separately from the heater 210 it will be understood that it may be integrated into the heater 210, such as by forming the heater with a positive thermal coefficient (“PTC”) heating chip such as a doped polycrystalline ceramic based on barium titanate. The safety system 214 may regulate the temperature of the heater 210 and maintain the temperature of the extruder 200 within a safe operating temperature. In some embodiments, the safety system 214 may comprise a device constructed at least partially from a positive thermal coefficient (PTC) material with self-limiting temperature characteristics.

In embodiments using PTC ceramics, the heater(s) 210 may be formed into any shape desired. The heaters 210 may be cylinders, rings, or any other shape chosen by the manufacturer. The heaters 210 may be connected to a power source (not shown) by electrical connectors 216. In operation, the PTC heating chips may limit heating within the extruder 200 to any desired maximum temperature. The heaters 210 may conveniently be potted directly into openings within the integrated nozzle 202 with any suitable potting material 215 in order to mechanically secure the heater 210 within the integrated nozzle 202.

The receiver 204 may be connected to the integrated nozzle 202 by a variety of means. In the embodiment shown, the receiver 204 is connected at connector 218. Connector 218 may be a slip joint, a threaded connection or any other type of mating connection known in the art that allows for a build material to be transferred from a chamber 220 of the receiver 204 to the chamber 212 in the integrated nozzle 202. The receiver may be made from any insulating material that isolates the heat from the integrated nozzle 202 so that the build material is only melted within the integrated nozzle. In some embodiments, the receiver 204 is formed from a ceramic material. In some embodiments, one end of the chamber 220 is chamfered to form a funnel 222. The funnel 222 compensates for variability in the feeding of the build material into the receiver.

The insulating sleeve 206 may fit about the integrated nozzle 202 and the receiver 204, and may form an interference fit to further secure the receiver 204 to the integrated nozzle 202. In some embodiments, the insulating sleeve 206, the integrated nozzle 202 and the receiver 204 are assembled by sliding the insulating sleeve 206 over the integrated nozzle and resting against a flange 224 of the integrated nozzle 202, and then the receiver 204 may be slipped into the sleeve 206 and attached to the connector 218 of the integrated nozzle 202. In some embodiments, the connector 218 has threads corresponding to threads on the receiver 204. In this embodiment, the receiver 204 may be threaded onto the integrated nozzle 202 at connector 218 until the flanges 224, 226 are firmly connected to the sleeve at opposing ends thereof.

The insulating sleeve 206 may have an opening 228 to allow access for electrical connectors 216, which may be sealed with a bushing or other arrangement after assembly. In general, the sleeve 206 may provide a thermal barrier to retain heat from the heater 210 within the extruder 200. The insulating sleeve 206 may be formed of the device of claim 8 wherein the thermal barrier is formed of Polytetrafluoroethylene (PTFE), or any other suitable material.

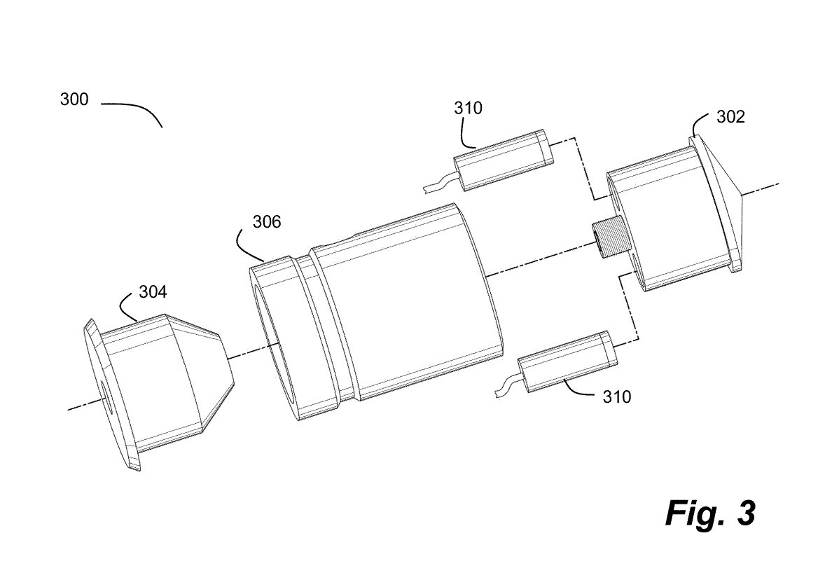

FIG. 3 shows an exploded view of an extruder 300. In general, the extruder may include an integrated nozzle 302, a receiver 304, an insulating sleeve 306 and one or more heaters 310 as described above. This assembly permits integrated thermal regulation of the extruder 300 with a small number of parts that can be easily assembled in a few assembly steps.

The one or more heaters 310 may, for example, be removable and replaceable cartridges such as cylinders that fit into mating holes within the integrated nozzle 202. The heaters 310 may be non-permanently secured within the mating holes with any suitable potting material or other material(s).

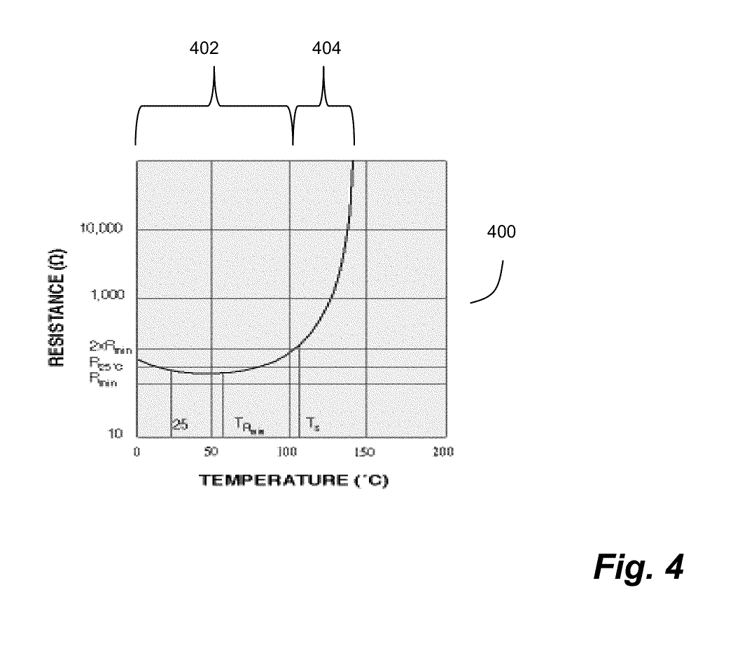

FIG. 4 shows a characteristic resistance temperature relationship 400 for a PTC heating element that may be used with the devices described above.

A PTC material with a positive thermal coefficient generally exhibits an increase in electrical resistance with an increase in temperature. The higher the coefficient, the greater an increase in electrical resistance for a given temperature increase. In general, a PTC material has a typical resistance-temperature relationship 400 with two operating ranges. In a first operating range 402, the resistance is relatively constant with respect to temperature. While the thermal coefficient (i.e., the slope of the characteristic curve) may increase or decrease somewhat within this range, the resistance does not increase substantially with an increase in temperature. Within this range, the temperature may be controlled by controlling an applied voltage. In a second operating range 404, the resistance increases rapidly with increases in temperature. In this second operating range 404, the positive thermal coefficient can effectively limit the temperature of the material by rapidly increasing resistance to reduce power independently from the applied voltage. As used herein, the term “operating range” is intended to refer generally to an operating range in which temperature can be practically increased with an increase in voltage, and the term “operating limit” is intended to refer to that temperature at which temperature cannot be practically increased with an increase in voltage. For extrusion-based fabrication processes, the operating range (where controlled heating is desired) may usefully span from about 200° to about 240° Celsius, or for a wider array of build materials, from about 90° (e.g., for PCL) to about 280° (e.g., for Nylon), or any other useful operating range for heating a build material or the like, thus providing a controllable heat within that first operating range. The operating limit may usefully be about 220° Celsius, about 240° Celsius, or any other suitable upper boundary for safety or for the use of a particular build material. In this manner, the heater 210 may provide an effective, self-regulating limit on temperature independent of an applied voltage.

It will be understood that the operating range for a heater may include the first operating range 402 described above, along with some portion of the second operating range 404 in which resistance begins to increase rapidly. While operation of a PTC heater may exhibit substantially linear heating behavior (i.e., change in temperature as a function of applied voltage) within the operating range, the characteristic resistance-temperature relationship 400 will not typically be perfectly constant or linear within the first operating range 402. As such, the description of ranges above, and the various minimums, maximums, thresholds, and ranges provided herein will be understood to refer to general operating characteristics of a heating element rather than precise values or relationships, the variability of which will be readily appreciated by one of ordinary skill in the art.

To test the use of PTC heating chips, a commercially available PTC chip having a first operating range 402 ending at about 100° Celsius was driven with a 24V source designed to regulate other heating elements at 240° Celsius. The maximum temperature achieved was limited to about 211° due to the resistive increase in the PTC chip. Of course, the design of a particular PTC chip may be adapted to more particularly achieve a maximum temperature suitable to a particular heating application, such as heating build material to a maximum of 240° Celsius, and all such variations suitable for use with the extrusion techniques and materials contemplated herein are intended to fall within the scope of this disclosure.

The design of PTC heating chips is well known in the art, and may be adapted to achieve a range of operating characteristics. For example, a PTC heating chip may be designed for a specific target temperature, a maximum allowable temperature, a heating time (with or without accounting for materials to be heated), electrical characteristics, mechanical characteristics (shape, size, etc.), and so forth. One of ordinary skill in the art may design a specific PTC heating chip suitable for the operating characteristics described above, or more generally for use in a thermally-based extrusion process, as contemplated herein. In some embodiments, the PTC heating chip may be configured to provide a predetermined temperature without external temperature control or regulation.

While particular embodiments of the present invention have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A device comprising:
an extruder;
a thermal core in the extruder having a chamber for receiving and conducting a build material;
at least one heating element adjacent to the thermal core configured to generate enough heat to melt the build material in the thermal core;
an extrusion tip at one end of the extruder configured to direct the molten build material; and
a safety system integrated into the heating element to regulate the temperature and prevent the heating element from exceeding a predetermined operating temperature.

2. The device of claim 1 wherein the safety system comprises a ceramic chip with a positive thermal coefficient (PTC).

3. The device of claim 2 wherein the heating element has an operating range for the temperature in which the temperature can be controlled by controlling an applied voltage.

4. The device of claim 3 wherein the heating element has an operating limit above which the temperature does not substantially increase with an increase in applied voltage.

5. The device of claim 2 wherein the PTC element is configured to regulate the temperature at a maximum of 240° Celsius.

6. The device of claim 3 wherein the operating range is about 0° to about 240° Celsius.

7. The device of claim 4 wherein the operating limit is about 240° Celsius.

8. The device of claim 1 further comprising a thermal barrier surrounding the extruder to retain heat within the thermal core.

9. The device of claim 8 wherein the thermal barrier is formed of Polytetrafluoroethylene (PTFE).

10. The device of claim 8 wherein the thermal barrier is formed of a ceramic.

11. The device of claim 1 further comprising a three-dimensional printer wherein the extruder is configured within the three-dimensional printer.

12. The device of claim 11 wherein the three-dimensional printer is a fused deposition modeling machine.

13. An extruder for a three-dimensional printer comprising:
an opening to receive a build material;
a thermal core having a chamber to receive the build material;
a heating element near the thermal core to heat the build material into a liquid form, the heating element including a positive thermal coefficient (PTC) chip to regulate a temperature of the heating element to a predetermined threshold; and
an extrusion tip to extrude the liquid form of the build material.

14. The extruder of claim 13 further comprising a power supply coupled to the heating element and configured to controllably provide power to the heating element.

15. The extruder of claim 13 wherein the positive thermal coefficient chip is a ceramic chip.

16. The extruder of claim 13 wherein the PTC chip has an operating range of about 0° to 240° Celsius.

17. The device of claim 13 wherein the PTC chip has an operating limit of about 220° Celsius.

18. The extruder of claim 13 wherein the PTC chip has an operating limit of about 240° Celsius.

19. The extruder of claim 13 further comprising a plurality of heating elements, each formed of a PTC chip positioned near the thermal core.

20. A device comprising:
an extruder;
a thermal core in the extruder having a chamber for receiving and conducting a build material;
at least one heating element adjacent to the thermal core configured to generate enough heat to melt the build material in the thermal core, the at least one heating element forming a removable and replaceable cartridge within the extruder;
an extrusion tip at one end of the extruder configured to direct the molten build material.

21. The device of claim 20 wherein the at least one heating element includes a positive thermal coefficient (PTC) chip.

22. The device of claim 21 further comprising a potting material to retain the removable and replaceable cartridge within the extruder.
